(19) United States
(12) Patent Application Publication
(10) Pub. No.: US 2024/0219988 A1
(43) Pub. Date: Jul. 4, 2024

(54) CHIPLET INTERCONNECT POWER STATE MANAGEMENT

(71) Applicants: Advanced Micro Devices, Inc., Santa Clara, CA (US); ATI Technologies ULC, Markham (CA)

(72) Inventors: Nicholas Carmine DeFiore, Austin, TX (US); Sridhar Varadharajulu Gada, Austin, TX (US); Benjamin Tsien, Santa Clara, CA (US); YanFeng Wang, Markham (CA); Steven Zhou, Markham (CA); Duanduan Chen, Markham (CA); Malcolm Earl Stevens, Santa Clara, CA (US)

(73) Assignees: Advanced Micro Devices, Inc., Santa Clara, CA (US); ATI Technologies ULC, Markham (CA)

(21) Appl. No.: 18/336,541

(22) Filed: Jun. 16, 2023

Related U.S. Application Data
(60) Provisional application No. 63/478,340, filed on Jan. 3, 2023.

(51) Int. Cl. G06F 1/3209

(52) U.S. Cl. CPC G06F 1/3209

(57) ABSTRACT

The disclosed device for power management of chiplet interconnects includes multiple chiplets connected via multiple interconnects. The device also includes a control circuit that detects activity states of the chiplets and manages power states of the interconnects based on the detected activity states. Various other methods, systems, and computer-readable media are also disclosed.

### CROSS REFERENCE TO RELATED APPLICATION

This application claims the benefit of U.S. Provisional Application No. 63/478,340, filed 3 Jan. 2023, the disclosure of which is incorporated, in its entirety, by this reference.

### BACKGROUND

As computing demands increase, different types of processor architectures have allowed improved computing performance. For example, a chiplet architecture can spread processing tasks of a device across multiple chiplets which can be specialized for certain processing tasks (e.g., graphics processing). With increased power demand for the improved performance, power management of the device includes managing power states of the chiplets. However, the interconnects connecting the chiplets themselves can draw power.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for chiplet interconnect power state management.

FIG. 2 is a block diagram of an exemplary chiplet interconnect architecture.

FIGS. 3A-C illustrate tables of various power states for interconnects based on chiplet activity levels.

FIG. 4 is a flow diagram of an exemplary method for chiplet interconnect power state management.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to managing power states of chiplet interconnects. As will be explained in greater detail below, implementations of the present disclosure can use the activity levels of chiplets for placing corresponding interconnects into appropriate power states. By managing interconnect power states, power consumption can be reduced, particularly during idle states, without significantly degrading performance.

In one implementation, a device for managing power states of chiplet interconnects includes a plurality of chiplets connected via a plurality of interconnects, and a control circuit configured to detect an activity state of at least one of the plurality of chiplets, and manage a power state of at least one of the plurality of interconnects based on the detected activity state.

In some examples, the control circuit is configured to manage the power state of the at least one of the plurality of interconnects by reducing a power state of the interconnect when the corresponding chiplet is idle. In some examples, the control circuit is configured to increase the power state of the interconnect when the corresponding chiplet becomes active.

In some examples, the control circuit is configured to manage the power state of at least one of the plurality of interconnects by placing the interconnect into a deep power state when the corresponding chiplet and chiplets that communicate with the corresponding chiplet are idle. In some examples, the control circuit is configured to increase a power state of the interconnect from the deep power state when at least one of the chiplets that communicate with the corresponding chiplet becomes active.

In some examples, the control circuit is configured to manage the power state of at least one of the plurality of interconnects by placing the interconnect into a shallow power state when the corresponding chiplet is idle and at least one chiplet that communicates with the corresponding chiplet is active.

In some examples, the device further includes a second plurality of chiplets connected via a second plurality of interconnects and the control circuit is further configured to manage power states of the second plurality of interconnects based on activity states of the second plurality of chiplets. In some examples, the control circuit manages the power states of the second plurality of interconnects independently from the activity states of the plurality of chiplets.

In some examples, reduced power states for the interconnects restrict probe traffic. In some examples, the control circuit is configured to manage the power state of each of the plurality of interconnects based on a power management policy relating to the activity states of the corresponding chiplets.

In one implementation, a system for managing power states of chiplet interconnects includes a physical memory, at least one physical processor comprising a plurality of chiplets configured to intercommunicate via a plurality of interconnects, and a control circuit. The control circuit is configured to detect an activity state of each of the plurality of chiplets, and manage a power state of each of the plurality of interconnects based on the activity states of the corresponding chiplets.

In some examples, the control circuit is configured to manage the power state of each of the plurality of interconnects by reducing a power state of the interconnect when the corresponding chiplet is idle and increasing the power state of the interconnect when the corresponding chiplet becomes active.

In some examples, the control circuit is configured to manage the power state of each of the plurality of interconnects by placing the interconnect into a deep power state when the corresponding chiplet and chiplets that communicate with the corresponding chiplet are idle and increasing a power state of the interconnect from the deep power state when at least one of the chiplets that communicate with the corresponding chiplet becomes active.

In some examples, the control circuit is configured to manage the power state of each of the plurality of interconnects by placing the interconnect into a shallow power state when the corresponding chiplet is idle and at least one chiplet that communicates with the corresponding chiplet is active.

In some examples, the system further includes a second plurality of chiplets connected via a second plurality of interconnects and the control circuit is further configured to manage, independently from the activity states of the plurality of chiplets, a power state of each of the second plurality of interconnects based on activity states of the corresponding chiplets of the second plurality of chiplets.

In some examples, reduced power states for the interconnects restrict probe traffic. In some examples, the control circuit is configured to manage the power state of each of the plurality of interconnects based on a power management policy relating to the activity states of the corresponding chiplets.

In one implementation, a method for managing power states of chiplet interconnects includes (i) detecting an activity state of a chiplet of a plurality of chiplets, (ii) applying a power management policy using the detected activity state to select a power state for an interconnect of a plurality of interconnects that corresponds to the chiplet, and (iii) placing the interconnect into the selected power state.

In some examples, the power management policy includes selecting a shallow power state for the interconnect when the chiplet is idle and at least one chiplet that communicates with the chiplet is active. In some examples, the power management policy includes selecting a deep power state when the chiplet and chiplets that communicate with the chiplet are idle.

Features from any of the implementations described herein can be used in combination with one another in accordance with the general principles described herein. These and other implementations, features, and advantages will be more fully understood upon reading the following detailed description in conjunction with the accompanying drawings and claims.

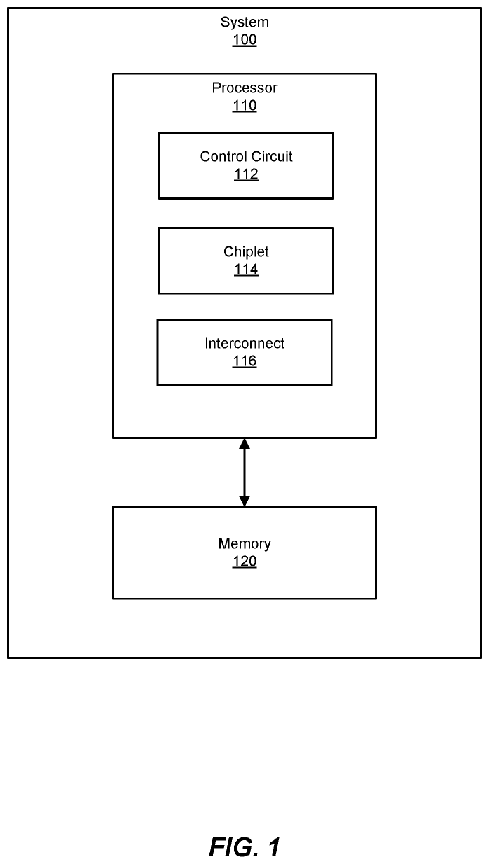

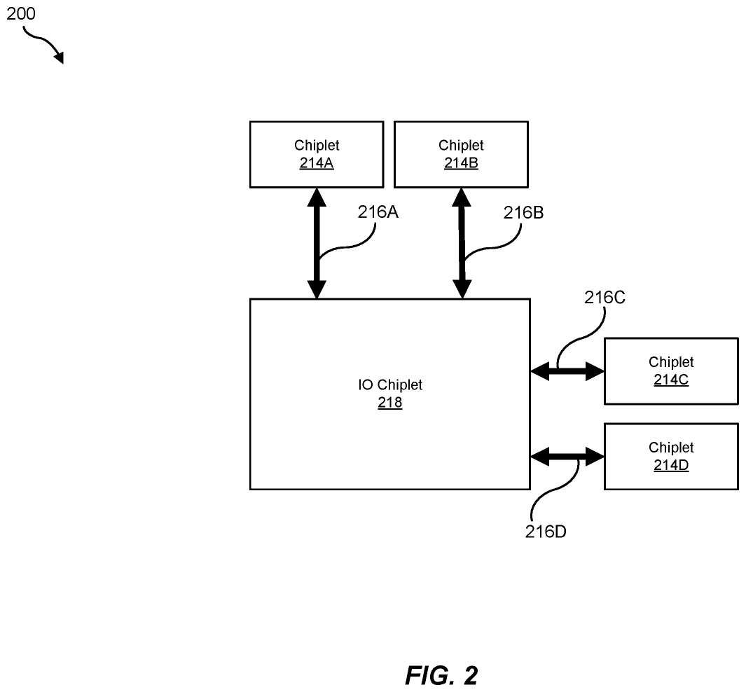

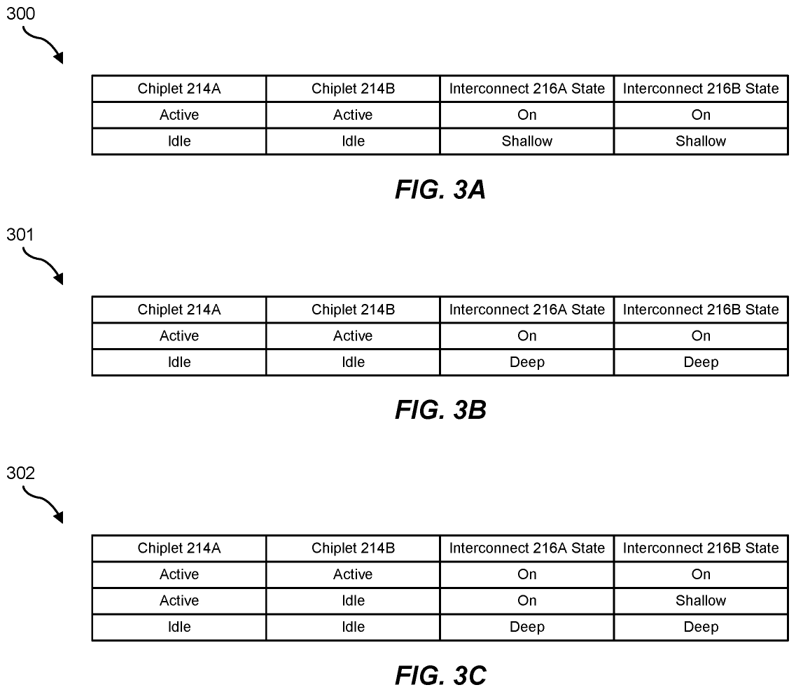

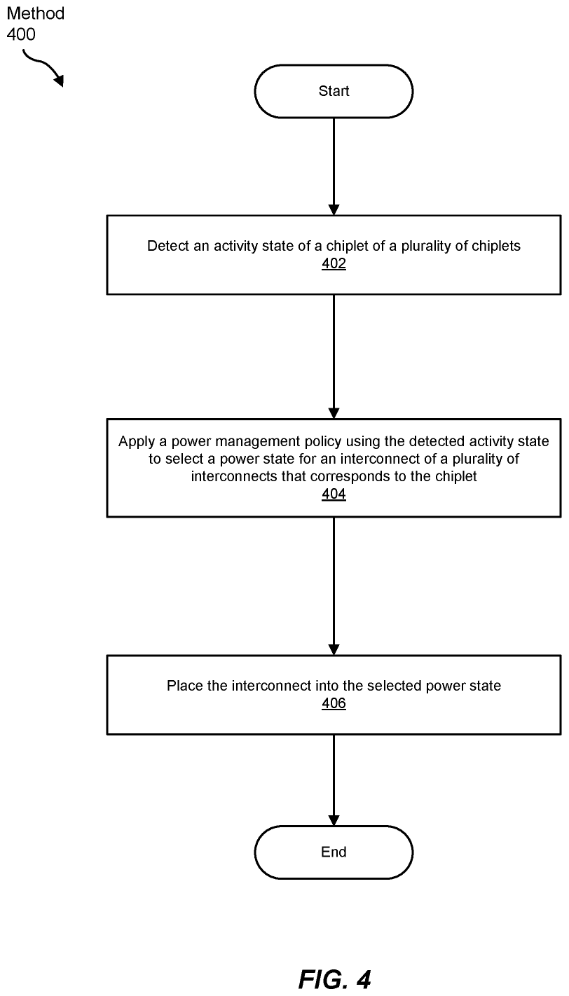

The following will provide, with reference to FIGS. 1-4, detailed descriptions of managing power states of chiplet interconnects. Detailed descriptions of example systems for chiplet interconnect power state management will be provided in connection with FIGS. 1 and 2. Detailed descriptions of example chiplet interconnect power state management policies will be provided in connection with FIGS. 3A-3C. Detailed descriptions of corresponding computer-implemented methods will also be provided in connection with FIG. 4.

FIG. 1 is a block diagram of an example system 100 for power state management of chiplet interconnects. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110. Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, chiplets (e.g., smaller and in some examples more specialized processing units that can coordinate as a single chip), microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

As further illustrated in FIG. 1, processor 110 includes a control circuit 112, a chiplet 114, and an interconnect 116. Control circuit 112 corresponds to one or more controllers for power management of chiplet interconnects (e.g., interconnect 116) and includes circuitry and/or instructions for placing chiplet interconnects into desired power states. In some examples, control circuit 112 can manage power states of additional components, such as chiplet 114. Chiplet 114 corresponds to one or more chiplets of processor 110. Interconnect 116 corresponds to one or more interconnects of links for chiplet 114 to various other components of processor 110. In some examples, system 100 can correspond to a computing system such as a server system having multiple processors (e.g., processor 110 can correspond to multiple processors) each having chiplets (e.g., one or more chiplet 114) with interconnects (e.g., one or more interconnect 116). In some examples, control circuit 112 can correspond to multiple control circuits or controllers that can, in some implementations, communicate or otherwise coordinate with each other for power management of chiplet interconnects as described herein.

FIG. 2 illustrates a device 200 (corresponding to system 100) having a chiplet architecture including a chiplet 214A (corresponding to an instance of chiplet 114), a chiplet 214B (corresponding to another instance of chiplet 114), a chiplet 214C (corresponding to another instance of chiplet 114 and more specifically a graphics chiplet), a chiplet 214D (corresponding to another instance of chiplet 114 and more specifically another graphics chiplet), and an IO chiplet 218. In some examples, a chiplet refers to small integrated circuits designed for a particular functionality or subset of a functionality that can work together as a single larger integrated circuit, and can each and/or collectively correspond to one or more of microprocessors, microcontrollers, Central Processing Units (CPUs), graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, graphics processing units (GPUs), portions of one or more of the same, variations or combinations of one or more of the same, and/or any other suitable physical processor.

IO chiplet 218 corresponds to a host die, such as an input/output die (IOD) or other central die for coordinating input and output for various chiplets such as chiplets 214A-214D. In some examples, IO chiplet 218 can include a control circuit for power management (e.g., control circuit 112) although in other examples the control circuit can be separate. Although not illustrated in FIG. 2, IO chiplet 218 can connect to various other interfaces, peripherals, buses, etc.

FIG. 2 further illustrates a chiplet link or interconnect 216A (corresponding to an instance of interconnect 116), an interconnect 216B (corresponding to another instance of interconnect 116), an interconnect 216C (corresponding to another instance of interconnect 116), and an interconnect 216D (corresponding to another instance of interconnect 116). In some examples, a link or interconnect refers to a circuit or other communicative path allowing direct communication between connected dies and/or chiplets. Although in FIG. 2 the interconnects (e.g., interconnects 216A-216D) respectively connect the chiplets (e.g., chiplets 214A-214D) to the host die (e.g., IO chiplet 218), in other examples, interconnects can connect chiplets themselves (e.g., connecting chiplet 214A to chiplet 214B, etc.). The interconnects can also allow communication between respective caches of the chiplets, such as probes for the caches. When managing a cache hierarchy, probes are sent to maintain coherency between caches (e.g., to prevent stale cached data from being operated on).

As will be described further herein, a power management policy can be applied to the interconnects based at least in part on their corresponding chiplets. Although in some examples a global policy can be applied to all chiplets (e.g., chiplets 214A-214D), in other examples, separate policies can be used for groups of chiplets. For instance, in FIG. 2, chiplet 214A and chiplet 214B can correspond to compute chiplets, which can operate separately and/or independently from chiplet 214C and chiplet 214D (e.g., a graphics chiplets). In other words, chiplets 214A and 214B do not necessarily share workloads with chiplets 214C and 214D such that the activity states of each group of chiplets are not relevant for power management of the other group. Thus, chiplets 214C and 214D and interconnects 216C and 216D can be managed in a separate policy.

FIGS. 3A-3C illustrate various tables, such as a table 300, a table 301, and a table 302, respectively. Each of table 300, table 301, and table 302 represent interconnect power state management policies and refer to the chiplets and interconnects presented in FIG. 2. In some examples, a controller (e.g., control circuit 112) can implement one or more of these policies, for instance by observing and activity level of the chiplets using various hardware and/or software tools and commanding the interconnects to enter the desired power states.

Table 300 corresponds to a simple management policy in which an interconnect can be placed in either an on state or a reduced power state (e.g., a shallow power state), based on an activity level (e.g., active, or idle) of the corresponding chiplet. For example, when chiplet 214A is active, the corresponding interconnect 216A is on, and when chiplet 214A is idle, the controller reduces a power state of interconnect 216A to a shallow power state. More specifically, when both chiplet 214A and chiplet 214B are idle (e.g., chiplets that can communicate with each other for certain processing tasks are both idle, indicating little or no current workload), the corresponding interconnect 216A and interconnect 216B can be placed in the shallow power state.

By placing an interconnect into a shallow power state, rather than a deep power state, a delay or latency overhead for powering up the interconnect can be avoided when the corresponding chiplet becomes active. For example, if chiplet 214A becomes active and needs to communicate with chiplet 214B, interconnect 216A can be powered on more quickly than if interconnect 216A was in the deep power state. Exiting a reduced power state can incur a latency which can affect probe traffic, for instance impacting components requiring timelines of probes being services, and can also affect request bandwidth of components that require probes to a chiplet. Accordingly, in some examples the shallow power states can further allow probes to be sent/received along the interconnect. In yet other examples, the shallow power state can pause probes from being sent/received along the interconnect for a shorter time than the deep power state. However, even in the shallow power state, the interconnect unnecessarily draws power, although the corresponding chiplet is idle.

Table 301 presents an improved power management policy. When both chiplet 214A and chiplet 214B are idle (indicating little or no current workload), no communication between the chiplets is expected. Thus, interconnect 216A and interconnect 216B can be placed in a further reduced power state (e.g., a deep power state) for further reduction in power consumption. In other words, because chiplet 214A and chiplet 214B are idle and in low power states themselves, the risk of the chiplets needing to communicate for a workload (and requiring quick powering on of an interconnect) is minimal. Additionally, because chiplet 214A and chiplet 214B are idle, their corresponding caches are also not in use such that probes to these caches are unnecessary (e.g., probe bandwidth for flushed caches can be zero). Accordingly, placing interconnect 216A and interconnect 216B into the deep power state can further avoid spending power on interconnect 216A and interconnect 216B when not in use by any coherence traffic, including probes.

Table 302 presents another improved power management policy. In table 302, an additional scenario, in which chiplet 214A is active and chiplet 214B is idle, is included. In this scenario, interconnect 216A is kept on because chiplet 214A is active. Interconnect 216B is placed in the shallow power state because chiplet 214B is idle. Rather than putting interconnect 216B in the deep power state, interconnect 216B is placed in the shallow power state to reduce overhead of powering up interconnect 216B (e.g., as compared to the deep power state) if chiplet 214A communicates to chiplet 214B. Thus, power savings are realized over the simple policy without significant reduction in performance.

In some implementations, the power management policy can be tuned. For example, the power management policy can be tuned to favor performance (e.g., favoring shallower power states) or for aggressive power savings (e.g., favoring deeper power states). In some implementations, the controller can dynamically update the power management policy, for example by learning and/or otherwise determining which chiplets tend to communicate with which other chiplets for managing the corresponding interconnects, detecting usage patterns of interconnects with respect to activity of the corresponding chiplets, etc. For example, the power management policy can be updated to include different contexts between chiplets, such as adding scenarios between chiplets 214C and/or 214D and chiplets 214A and/or 214B, removing scenarios, etc.

Moreover, although FIGS. 3A-3C illustrate two chiplet/interconnect pairs and two low power states (e.g., shallow, and deep) as simplified examples, in other examples, various permutations of chiplets and states (e.g., scenarios) can be combined with various other power states as needed. Additionally, in other examples, power management policies can be defined by rules, heuristics, factor-based decisions, etc.

FIG. 4 is a flow diagram of an exemplary method 400 for chiplet interconnect power state management. The steps shown in FIG. 4 can be performed by any suitable circuit, computer-executable code and/or computing system, including the system(s) illustrated in FIGS. 1 and/or 2. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein detect an activity state of a chiplet of a plurality of chiplets. For example, control circuit 112 detects or otherwise identifies an activity state of chiplet 114.

The systems described herein can perform step 402 in a variety of ways. In one example, control circuit 112 can observe an activity level of chiplet 114 and/or read a corresponding status register.

At step 404 one or more of the systems described herein apply a power management policy using the detected activity state to select a power state for an interconnect of a plurality of interconnects that corresponds to the chiplet. For example, control circuit 112 can select a power state for interconnect 116 to apply a power management policy using the detected activity state of chiplet 114.

The systems described herein can perform step 404 in a variety of ways. In one example, the power management policy can include selecting a shallow power state for the interconnect when the chiplet is idle and at least one chiplet that communicates with the chiplet is active (see, e.g., table 302). In some examples, the power management policy can include selecting a deep power state when the chiplet and chiplets that communicate with the chiplet are idle (see, e.g., table 302).

At step 406 one or more of the systems described herein place the interconnect into the selected power state. For example, control circuit 112 can place interconnect 116 into the selected power state.

The systems described herein can perform step 406 in a variety of ways. In one example, control circuit 112 can instruct interconnect 116 to enter the selected power state.

As detailed above, the systems and methods described herein provide power state management of chiplet interconnect links based on the activity level of all chiplets. With chiplet architectures there is a need to manage the link states between the chiplets. Chiplet interconnect links can draw large amounts of power and, by leaving the links up, can increase probe request traffic. As such, it can be advantageous to reduce the power draw and limit the probe requests through these links through smart management of link power states. Additionally, this management can extend to having asymmetric power states among the chiplets and interconnect links. This chiplet interconnect power state management can contribute power savings, but the accelerated processing unit (APU) needs to ensure it does not place the links in a power state at a non-optimal time that would impact performance. Thus, the systems and methods described herein monitor the activity of all the chiplets and use that to influence the power state the links transition to.

Specifically, when not all chiplets are active, the APU can save power by putting the non-active chiplet interconnect link(s) in a shallow power state. Since some chiplets are active, this means the APU is still doing work, just not at maximum capacity. The shallow power state is beneficial in this scenario because the moderate level of activity could quickly increase to require the resources of the inactive chiplet(s) As such, waking up the interconnect links from the shallow power state limits the performance downside of putting the link to sleep while saving a majority of the power possible. If the activity level instead decreases, more individual chiplets can be put in the shallow state until all chiplets become inactive. At this point, the APU would be considered idle and can transition all chiplet interconnect links to a deep power state to save maximum power when maximum performance is not needed. When the APU begins to see increased activity, all chiplet interconnect links can be brought back up the shallow power state with the number of links needed for activity waking all the way back up.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a plurality of chiplets connected via a plurality of interconnects; and
a control circuit configured to:
detect an activity state of at least one of the plurality of chiplets; and
manage a power state of at least one of the plurality of interconnects based on the detected activity state.

2. The device of claim 1, wherein the control circuit is configured to manage the power state of at least one of the plurality of interconnects by reducing a power state of an interconnect when a corresponding chiplet is idle.

3. The device of claim 2, wherein the control circuit is configured to increase the power state of the interconnect when the corresponding chiplet becomes active.

4. The device of claim 1, wherein the control circuit is configured to manage the power state of at least one of the plurality of interconnects by placing an interconnect into a deep power state when a corresponding chiplet and chiplets that communicate with the corresponding chiplet are idle.

5. The device of claim 4, wherein the control circuit is configured to increase a power state of the interconnect from the deep power state when at least one of the chiplets that communicate with the corresponding chiplet becomes active.

6. The device of claim 1, wherein the control circuit is configured to manage the power state of at least one of the plurality of interconnects by placing an interconnect into a shallow power state when a corresponding chiplet is idle and at least one chiplet that communicates with the corresponding chiplet is active.

7. The device of claim 1, wherein the device further comprises a second plurality of chiplets connected via a second plurality of interconnects and the control circuit is further configured to manage power states of the second plurality of interconnects based on activity states of the second plurality of chiplets.

8. The device of claim 7, wherein the control circuit manages the power states of the second plurality of interconnects independently from activity states of the plurality of chiplets.

9. The device of claim 1, wherein reduced power states for the plurality of interconnects restrict probe traffic.

10. The device of claim 1, wherein the control circuit is configured to manage the power state of each of the plurality of interconnects based on a power management policy relating to activity states of corresponding chiplets.

11. A system comprising:
a physical memory;
at least one physical processor comprising a plurality of chiplets configured to intercommunicate via a plurality of interconnects; and
a control circuit configured to:
detect an activity state of each of the plurality of chiplets; and
manage a power state of each of the plurality of interconnects based on activity states of corresponding chiplets.

12. The system of claim 11, wherein the control circuit is configured to manage the power state of each of the plurality of interconnects by reducing a power state of an interconnect when a corresponding chiplet is idle and increasing the power state of the interconnect when the corresponding chiplet becomes active.

13. The system of claim 11, wherein the control circuit is configured to manage the power state of each of the plurality of interconnects by placing an interconnect into a deep power state when a corresponding chiplet and chiplets that communicate with the corresponding chiplet are idle and increasing a power state of the interconnect from the deep power state when at least one of the chiplets that communicate with the corresponding chiplet becomes active.

14. The system of claim 11, wherein the control circuit is configured to manage the power state of each of the plurality of interconnects by placing an interconnect into a shallow power state when a corresponding chiplet is idle and at least one chiplet that communicates with the corresponding chiplet is active.

15. The system of claim 11, further comprising a second plurality of chiplets connected via a second plurality of interconnects and the control circuit is further configured to manage, independently from activity states of the plurality of chiplets, a power state of each of the second plurality of interconnects based on activity states of the corresponding chiplets of the second plurality of chiplets.

16. The system of claim 11, wherein reduced power states for the plurality of interconnects restrict probe traffic.

17. The system of claim 11, wherein the control circuit is configured to manage the power state of each of the plurality of interconnects based on a power management policy relating to the activity states of the corresponding chiplets.

18. A method comprising:
detecting an activity state of a chiplet of a plurality of chiplets;
applying a power management policy using the detected activity state to select a power state for an interconnect of a plurality of interconnects that corresponds to the chiplet; and
placing the interconnect into the selected power state.

19. The method of claim 18, wherein the power management policy includes selecting a shallow power state for the interconnect when the chiplet is idle and at least one chiplet that communicates with the chiplet is active.

20. The method of claim 18, wherein the power management policy includes selecting a deep power state when the chiplet and chiplets that communicate with the chiplet are idle.
